(19) United States
(12) Patent Application Publication
(10) Pub. No.: US 2007/0149117 A1
(43) Pub. Date: Jun. 28, 2007

(54) Signal transmitting/receiving method for increasing transmission efficiency in a wireless communication system using multiple antennas and system thereof

(75) Inventors: Sung-Soo Hwang, Suwon-si (KR); Young-Hoon Kwon, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/645,961

(22) Filed: Dec. 27, 2006

(30) Foreign Application Priority Data
Dec. 27, 2005 (KR) 2005-130852

(51) Int. Cl. H04B 7/15

(52) U.S. Cl. 455/11.1

(57) ABSTRACT

A method and system for transmitting and receiving signals to increase transmission efficiency in a wireless communication system using multiple antennas are provided. A relay node receives a first signal from a Base Station (BS) according to a first signal scheme and a second signal from a Mobile Station (MS) according to a second signal scheme. The relay node generates a third signal by XOR-operating the first signal and the second signal, multiplies the third signal by a weight matrix, and transmits the multiplied signal to the BS and the MS.

### PRIORITY

This application claims priority under 35 U.S.C. § 119 to an application filed in the Korean Intellectual Property Office on Dec. 27, 2005 and assigned Serial No. 2005-130852, the contents of which are incorporated herein by reference.

### BACKGROUND OF THE INVENTION

1. Field of the Invention

The present invention relates generally to a wireless communication system using multiple antennas, and in particular, to a system and method for transmitting/receiving a signal in a wireless communication system using multiple antennas.

2. Description of the Related Art

Wireless communication systems are now evolving from 3^{rd} Generation (3G) mobile communication systems to 4^{th} Generation (4G) mobile communication systems. The 4G mobile communication systems are under study to broaden radio propagation, i.e. coverage area as well as to increase data rate. A multi-hop scheme is one of the technologies developed to broaden coverage area. In the multi-hop scheme, a relay node designed with low cost relays signals to nodes at the periphery of a cell coverage area.

A drawback of the multi-hop scheme is that the relay node has to share limited radio resources with a Base Station (BS) and a Mobile Station (MS). More specifically, the relay node uses radio channel resources divided between BSs or between MSs, which leads to the requirement of twice as large radio channel resources. This problem will be described in detail with reference to FIGS. 1, 2 and 3.

FIG. 1 illustrates signal transmission/reception in a typical wireless communication system without any relay node.

Referring to FIG. 1, an MS 150 is located within a distance to a BS 100, which allows direct communication with the BS 100. The BS 100 transmits a DownLink (DL) signal to the MS in step 105 and the MS 150 transmits an UpLink (UL) signal to the BS 100 in step 110. The BS 100 and the MS 150 exchange the DL and UL signals in time division. Guard intervals 115 and 120 are interposed to distinguish the DL period 105 from the UL period 110.

As illustrated in FIG. 1, in the case of direct communication between the BS and the MS, radio channel resources are divided into halves in time, for use on the DL and the UL, and two guard intervals are required for distinguishing the DL period from the UL period. Alternatively, in the case where a relay node relays between the BS and the MS, more radio channel resources are needed for use in the relay node. Consequently, a data rate with respect to radio resources is decreased as much.

Referring to FIGS. 2 and 3, a description of problems encountered when a relay node relays signals for one MS exists and when a relay node relays signals for two MSs will be set forth herein.

FIG. 2 illustrates a signal transmission/reception in a wireless communication system where a relay node relays a signal to/from one MS.

Referring to FIG. 2, a BS 200 transmits a DL signal a destined for an MS 240 to a relay node 220 in step 201 and the relay node 220 forwards the DL signal a to an MS 240 in step 203. Also, in step 205 the relay node 220 receives a UL signal b from the MS 240 and in step 207 forwards it to the BS 200.

In the above case where the relay node 220 relays signals for the single MS 240, the relayed data is less than data that might be transmitted between the BS 200 and the MS 240 through direct communication. Moreover, two more guide intervals are required to distinguish the DL transmission/reception from the UL transmission/reception between the BS 200 and the relay node 220 and between the relay node 220 and the MS 240.

FIG. 3 illustrates signal transmission/reception in a wireless communication system where a relay node relays signals to/from two MSs.

Referring to FIG. 3, in step 301 a BS 300 sequentially transmits a DL signal a destined for a first MS 340 (MS 1) and a DL signal b destined for a second MS 360 (MS 2). The relay node 320 forwards the DL signal a to MS 1 in step 303 and forwards the DL signal b to MS 2 in step 305.

When the relay node 320 receives a UL signal c from MS 1 and a UL signal d from MS 2 in step 307 and 309, it forwards them to the BS 200 in step 311.

As described above, in the case where the relay node 320 relays signals from/to a plurality of MSs, MS 1 and MS 2, data transmission efficiency is further decreased and more guard intervals are required, compared to the cases illustrated in FIGS. 1 and 2.

### SUMMARY OF THE INVENTION

An object of the present invention is to substantially solve at least the above problems and/or disadvantages and to provide at least the advantages described below. Accordingly, the present invention provides a system and method for increasing data transmission efficiency using multiple antennas.

The present invention provides a system and method for maximizing resource utilization by transmitting/receiving signals in a wireless communication system using multiple antennas, in which a relay node transmits/receives signals to/from a BS in a Multiple-Input Multiple-Output (MIMO) scheme, transmits/receives signals to/from an MS in a Spatial Division Multiple Access (SDMA), and relays signals in a network coding scheme.

According to an aspect of the present invention, in a relay method of a relay node in a wireless communication system having a BS, the relay node, and an MS, the relay node receives a first signal from the BS according to a first signal scheme and a second signal from the MS according to a second signal scheme. The relay node generates a third signal by eXclusive OR (XOR)-operating the first signal and the second signal, multiplies the third signal by a weight matrix, and transmits the multiplied signal to the BS and the MS.

According to another aspect of the present invention, in a method of transmitting and receiving signals to and from a BS in an MS in a wireless communication system having the BS, a relay node, and the MS, the MS transmits a first signal destined for the BS to the relay node and receives a third signal from the relay node. Here, the third signal is generated by XOR-operating the first signal and a second signal transmitted from the BS and destined for the MS, multiplying the XOR signal by a weight matrix, and passing the multiplied signal through a radio channel. The MS detects the second signal transmitted from the BS by XOR-operating the third signal and the first signal known to the MS.

According to a further aspect of the present invention, in a method of transmitting and receiving signals to and from an MS in a BS in a wireless communication system having the BS, a relay node, and the MS, the BS transmits a first signal destined for the MS to the relay node and receives a third signal from the relay node. The third signal is created by XOR-operating the first signal and a second signal transmitted from the MS and destined for the BS, multiplying the XOR signal by a weight matrix, and passing the multiplied signal through a radio channel. The BS detects the second signal transmitted from the MS by XOR-operating the third signal and the first signal known to the BS.

According to still another aspect of the present invention, a signal transmitting and receiving system includes a BS, a relay node and an MS in a wireless communication system. The BS transmits a first signal destined for an MS to a relay node in a MIMO scheme. Upon receipt of a second signal from the relay node, the BS detects a third signal transmitted by the MS by XOR-operating the second signal and the first signal. The relay node receives the first signal from the BS and the third signal from the MS, generates the second signal by XOR-operating the first signal and the third signal, transmits the second signal to the BS and the MS in an SDMA scheme. The MS transmits the third signal to the relay node and upon receipt of the second signal, detects the first signal transmitted by the BS by XOR-operating the second signal and the third signal.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates signal transmission/reception in a typical wireless communication system without any relay node;

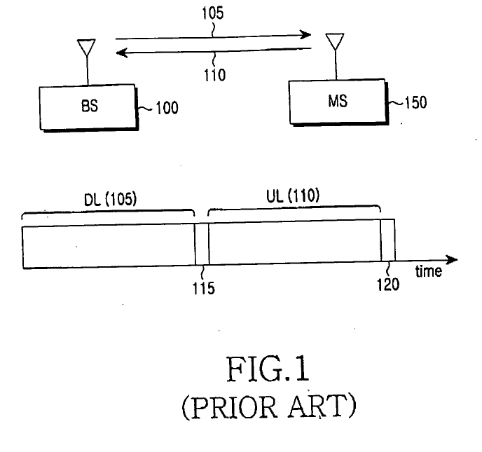

FIG. 2 illustrates signal transmission/reception in a wireless communication system where a relay node relays signals to/from one Mobile Station (MS);

FIG. 3 illustrates signal transmission/reception in a wireless communication system where a relay node relays signals to/from two MSs;

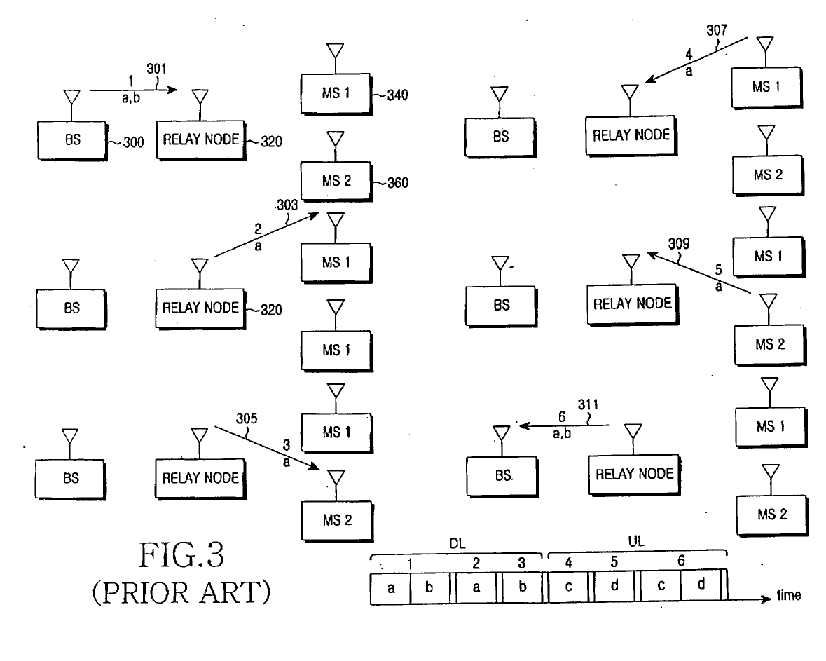

FIG. 4 illustrates signal transmission/reception among a Base Station (BS), a relay node, and MSs in a wireless communication system according to the present invention;

FIG. 5 is a ladder-type diagram illustrating a signal flow for signal transmission/reception among the BS, the relay node, and the MSs in the wireless communication system according to the present invention; and

FIG. 6 is a flowchart illustrating a relay operation in the relay node in the wireless communication system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention is intended to provide a signal transmitting/receiving system and method in a wireless communication system using multiple antennas, in which signals are transmitted/received between a BS and a relay node in a MIMO scheme and signals are transmitted/received between the relay node and an MS in an SDMA scheme. According to the present invention, the relay node relays signals to the BS and the MS in a network coding scheme, thereby increasing data transmission efficiency. The network coding scheme is a transmission scheme in which at least two received signals are eXclusive OR (XOR)-operated to one signal, for transmission.

The network coding scheme will be described under the assumption that one BS, one relay node, and one MS exist.

The BS first transmits a DL signal a to the relay node during a DL signal period, and the MS transmits a UL signal b to the relay node during a UL signal period.

Then the relay node XOR-operates the signals a and b to an XOR signal c and transmits the XOR signal c to the BS and the MS during a relay signal period. The relay signal period is defined as a time period for which the XOR signal is transmitted. The XOR signal is given as expressed in Equation (1) below:
c=a(+)b, (+) representing XOR (1)
The BS receives the signal c from the relay node. With knowledge of the signal a transmitted by the BS, the BS acquires the signal b transmitted by the MS by XOR-operating the signals a and c. Similarly, the MS receives the signal c from the relay node and with knowledge of the signal b transmitted by the MS, the MS acquires the signal a transmitted by the BS by XOR-operating the signals b and c. This operation is expressed as set forth in Equation (2) below:
a=c(+)b, (+)representing XOR
b=c(+)a, (+)representing XOR (2)

For instance, if a=10111 and b=01010, c=a(+)b=10111(+)01010=11101. Therefore, the BS recovers b=01010 by XOR-operating c and a, i.e. by c(+)a=11101(+)10111 and the MS recovers a=10111 by XOR-operating c and b, i.e. by c(+)b=11101(+)01010.

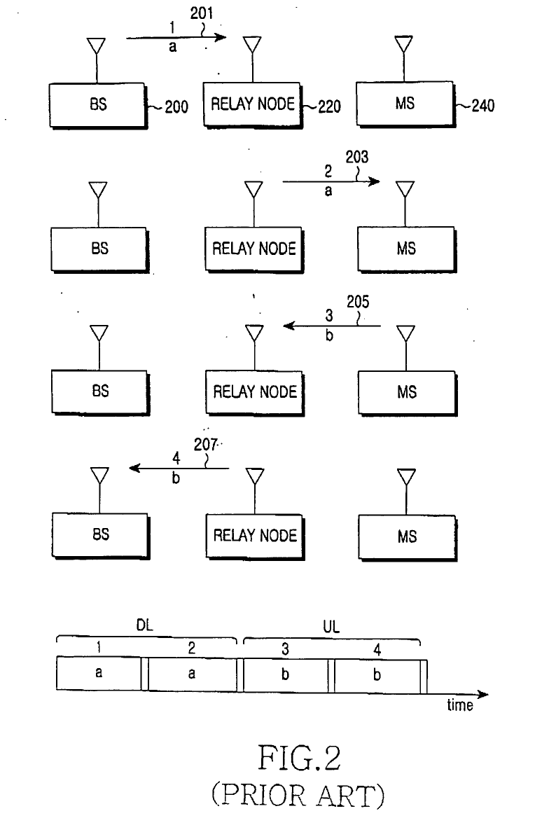

As described above, compared to the case illustrated in FIG. 2 where only a half of the total period except for four guard intervals is utilized, the use of the network coding scheme enables utilization of two-thirds of the total period except for three guard intervals, thus increasing data transmission efficiency.

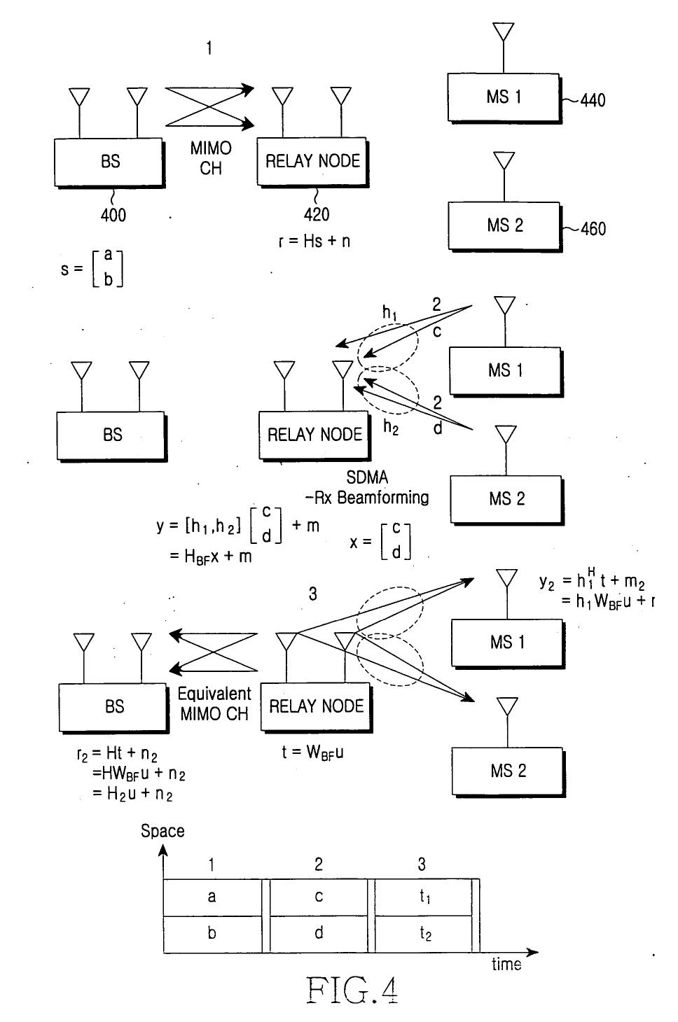

With reference to FIG. 4, a signal transmitting/receiving method for increasing data transmission efficiency in a wireless communication system according to the present invention will be described below. Notably, while the following description is made on the assumption of two MSs, the present invention is obviously applicable to any case with at least one MS.

FIG. 4 illustrates signal transmission/reception among a BS, a relay node, and MSs in a wireless communication system according to the present invention.

Referring to FIG. 4, a BS 400 and a relay node 420 each have a plurality of antennas. The BS 400 transmits signals a and b in MIMO by spatial division during the same time period (time period 1). The signal received from the BS 400 at the relay node 420 is given as set forth in Equation (3) below:
r=Hs+n, (3)
where s=[a, b]^{T}, H denotes a 2×2 MIMO channel matrix between the BS 400 and the relay node 420, and n denotes a Additive White Gaussian Noise (AWGN) vector added to the received signal r.

The relay node 420 detects the signals a and b by channel estimation and a MIMO reception algorithm such as Zero Forcing (ZF) or Minimum Mean Squared Error (MMSE). The signal detected by the MIMO reception algorithm are expressed as set forth in Equation (4) below:
ŝ=W_{MIMO}r, (4)
where W_{MIMO}=(HH^{H}+σ²I)^{-t} H^{H} in which σ² denotes a noise power measured at the receive antennas of the relay node 420 during time period 1, the superscript H denotes a Hermitian matrix, and I denotes an identity matrix.

Meanwhile, the relay node 420 receives signals c and d from a first MS 440 (MS 1) and a second MS 460 (MS 2) by spatial division during the same time period (time period 2). Notably, the signals c and d are separately received at the relay node 420 by beamforming.

Let the channel between the relay node 420 and MS 1 be denoted by a 2×1 vector, h₁ and the channel between the relay node 420 and MS 2 be denoted by a 2×1 vector, h₂. Then, the signals received from MS 1 and MS 2 at the relay node 420 are given as set forth in Equation (5) below:
y=h₁c+h₂d+m, (5)
where m is a 2×1 vector representing an AWGN added to the signals received at the relay node 420 from MS 1 and MS 2.

Equation (5) can be further expressed as set forth in Equation (6) below:

$$\begin{matrix}y = {h}_{1} c + {h}_{2} d + m \\ = [ {h}_{1} , {h}_{2} ] [ \begin{matrix}c \\ d\end{matrix} ] + m \\ = {H}_{BF} x + m\end{matrix} \qquad ( 6 )$$

where H_{BF}=[h₁, h₂] and

$$x = [ \begin{matrix}c \\ d\end{matrix} ] .$$

Using a beamforming algorithm such as ZF or MMSE, the channel estimate of the received signal y is given as set forth in Equation (7) below:
\hat{x}=W_{BF}y (7)
where W_{BF} is a 2×2 weight matrix by which to detect the original transmitted signal \hat{x} from the received signal y. W_{BF}=(H_{BF}H_{BF}^{H}+σ_{BF}²I)⁻¹ H_{BF}^{H} in which σ_{BF}² is a noise power measured at the receiving antenna of the relay node 420 during time period 2.

The relay node 420 XOR-operates the signals a, b, c and d received from the BS 400 and the MSs 440 and 460. Specifically, in the network coding scheme, the relay node 420 generates a signal u₁ by XOR-operating the signal a directed to MS 1 with the signal c directed from MS 1 to the BS 400, and generates a signal u₂ by XOR-operating the signal b directed to MS 2 with the signal d directed from MS 2 to the BS 400.

Thus, the signals u₁ and u₂ are given as set forth in Equation (8) below:
u₁=a(+)c
u₂=b(+)d (8)

The relay node 420 transmits the signals u₁ and u₂ by applying the weight W_{BF} to MS 1 and MS 2 as expressed in Equation (9) below:

$$t = {W}_{BF} ( \begin{matrix}{u}_{1} \\ {u}_{2}\end{matrix} ) = {W}_{BF} U , ( here t is a 2 \times 1 vector ) \qquad ( 9 )$$

The weighted signal transmission is equivalent to transmission beamforming in effect and thus MS 1 and MS 2 receive interference-free signals. For example, MS 1 receives a signal expressed as

$${h}_{1} t + p = {h}_{1} {W}_{BF} ( \begin{matrix}{u}_{1} \\ {u}_{2}\end{matrix} ) + p = {\hat{u}}_{1} + p .$$

That is, MS 1 receives the signal u₁ and MS 2 receives the signal u₂.

With knowledge of their transmitted signals, MS 1 and MS 2 detect the signals a and b transmitted by the BS 400. The signals a and b are expressed as set forth in Equation (10) below:
a=u₁(+)c
b=u₂(+)d (10)

Meanwhile, the BS 400 receives signal r expressed in Equation (11) below:

$$\begin{matrix}r = H t + n \\ = H {W}_{BF} U + n \\ = {H}_{2} U + n\end{matrix} \qquad ( 11 )$$

where U=[u₁,u₂,]^{T} (T denotes a transpose matrix) and H₂=HW_{BF}. Therefore, the BS 400 detects u₁ and u₂ by MIMO detection of the received signal U having the MIMO channel, H₂ and then detects the signals c and d by XOR-operating u₁ and u₂ by a and b, respectively, as expressed in Equation (12) below:
c=u₁(+)a
d=u₂(+)b (12)

As illustrated in FIG. 4, the BS and the relay node communicate with each other in the MIMO scheme, the relay node and the MSs communicate with each other in the SDMA scheme, and the relay node relays signals in the network coding scheme. Therefore, the amount of data transmitted for a unit time is increased spatially, thereby leading to the increase of data transmission efficiency.

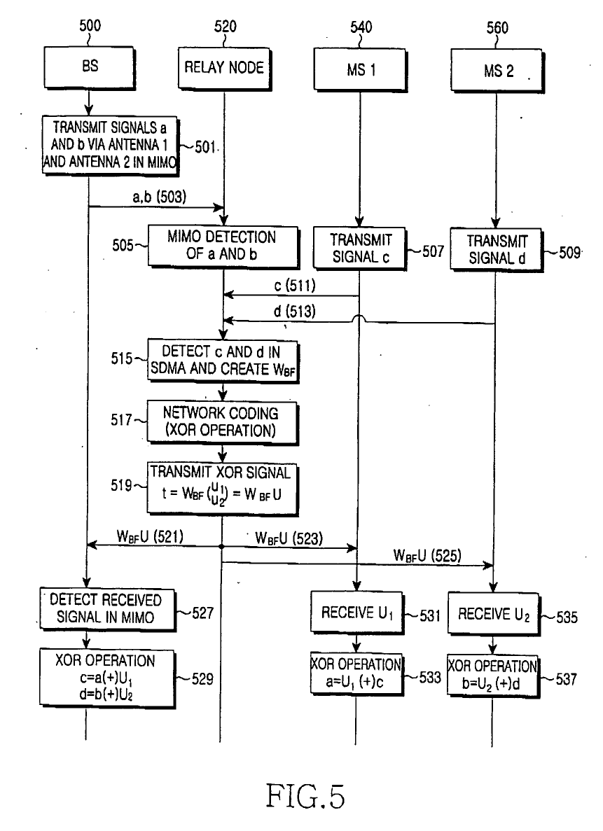

FIG. 5 is a diagram illustrating a signal flow for signal transmission/reception among the BS, the relay node, and the MSs in the wireless communication system according to the present invention.

Referring to FIG. 5, in steps 501 and 503 a BS 500 transmits DL signals a and b to a relay node 520 through a first Transmission (Tx) antenna (Tx antenna 1) and a second Tx antenna (Tx antenna 2) in a DL transmission period. It is assumed that the DL signal a is destined for a first MS 540 (MS 1) and the DL signal b is destined for a second MS 560 (MS 2).

In step 505, the relay node 520 performs MIMO detection (e.g. ZF or MMSE) on the received signals a and b.

Meanwhile, in steps 507 to 513, MS 1 and MS 2 transmit UL signals c and d to the relay node 520 in a UL transmission period.

The relay node 520 detects the signals c and d by separating them by beamforming in step 515. Simultaneously, the relay node 520 generates a weight matrix W_{BF}. Then the relay node 520 XOR-operates the signals a and c, and the signals b and d according to the network coding scheme in step 517. The relay node 520 transmits the resulting XOR signals u₁ and u₂ in the form of

$$t = {W}_{BF} ( \begin{matrix}{u}_{1} \\ {u}_{2}\end{matrix} ) = {W}_{BF} U$$

in step 519.

For the signal transmitted by the relay node 520, the BS 500 receives the signal given as Equation (11), MS 1 receives the signal expressed as

$${h}_{1} t + p = {h}_{1} {W}_{BF} ( \begin{matrix}{u}_{1} \\ {u}_{2}\end{matrix} ) + p = {\hat{u}}_{1} + p ,$$

and MS 2 receives the signal expressed as

$${h}_{2} t + q = {h}_{2} {W}_{BF} ( \begin{matrix}{u}_{1} \\ {u}_{2}\end{matrix} ) + q = {\hat{u}}_{2} + q$$

in steps 521, 523 and 525. Here, q denotes the noise at MS 2 during time period 3.

The BS 500 detects the signals u₁ and u₂ in step 527, and detects the signals c and d transmitted by MS 1 and MS 2 by XOR-operating u₁ and u₂ with the known signals a and b in step 529.

MS 1 receives the signal U₁ reflecting a channel status in step 531 and detects the signal a by XOR-operating U₁ with the known signal c in step 533. MS 2 receives the signal U₂ reflecting a channel status in step 535 and detects the signal b by XOR-operating U₂ with the known signal d in step 537.

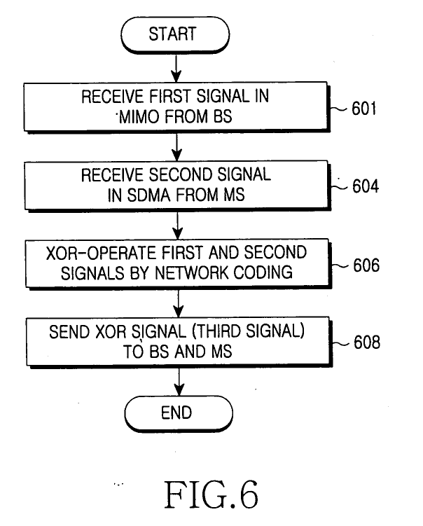

FIG. 6 is a flowchart illustrating a relay operation in the relay node in the wireless communication system according to the present invention.

Referring to FIG. 6, the relay node receives a first signal from the BS in step 602. The first signal is generated in the MIMO scheme, destined for an MS. The relay node receives a second signal from the MS without interference from other MSs by antenna beamforming, i.e. in SDMA in step 604. The relay node XOR-operates the first and second signals in the network coding scheme in step 606 and transmits the XOR signal as a third signal to the BS and the MS in step 608. Upon receipt of the third signal, the BS and the MS detect the second and first signals by XOR-operating the third signal with the first and second signals, respectively.

As described above, in the wireless communication system that adopts a relay scheme according to the present invention, the relay node transmits/receives signals to/from the BS in MIMO, transmits/receives signals to/from the MS in SDMA, and relays signals using the network coding scheme. Therefore, radio resource utilization and data transmission efficiency are increased.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A relay method of a relay node in a wireless communication system having a Base Station (BS), the relay node, and a Mobile Station (MS), comprising the steps of:
receiving a first signal from the BS according to a first signal scheme and a second signal from the MS according to a second signal scheme;
generating a third signal by eXclusive OR (XOR)-operating the first signal and the second signal; and
transmitting the third signal to the BS and the MS using a multi-antenna scheme.

2. The relay method of claim 1, wherein the step of transmitting the third signal further comprises multiplying the third signal by a weight matrix.

3. The relay method of claim 1, wherein the multi-antenna scheme is a Spatial Division Multiplexing (SDM) scheme.

4. The relay method of claim 1, wherein the first signal scheme is a Multiple-Input Multiple-Output (MIMO) scheme.

5. The relay method of claim 1, wherein the second signal scheme is a Spatial Division Multiple Access (SDMA) scheme.

6. The relay method of claim 1, wherein the first signal is directed from the BS to the MS.

7. The relay method of claim 1, wherein the second signal is directed from the MS to the BS.

8. A method of transmitting and receiving signals to and from a Base Station (BS) in a Mobile Station (MS) in a wireless communication system having the BS, a relay node, and the MS, comprising the steps of:
transmitting a first signal destined for the BS to the relay node;
receiving a third signal from the relay node, the third signal being generated by eXclusive OR (XOR)-operating the first signal and a second signal transmitted from the BS and destined for the MS, multiplying the XOR signal by a weight matrix, and transmitting the multiplied signal through a radio channel; and
detecting the second signal transmitted from the BS by XOR-operating the third signal and the first signal known to the MS.

9. The method of claim 8, wherein the second signal is based on a Multiple-Input Multiple-Output (MIMO) scheme for multiple antennas and the third signal is based on antenna beamforming.

10. A method of transmitting and receiving signals to and from a Mobile Station (MS) in a Base Station (BS) in a wireless communication system having the BS, a relay node, and the MS, comprising the steps of:
transmitting a first signal destined for the MS to the relay node;
receiving a third signal from the relay node, the third signal being generated by eXclusive OR (XOR)-operating the first signal and a second signal transmitted from the MS and destined for the BS, and multiplying the XOR signal by a weight matrix; and
detecting the second signal transmitted from the MS by XOR-operating the third signal and the first signal known to the BS.

11. The method of claim 10, wherein the first signal is based on a Multiple-Input Multiple-Output (MIMO) scheme for multiple antennas and the second signal is based on an antenna beamforming.

12. A signal transmitting and receiving system in a wireless communication system, comprising:
a Base Station (BS) for transmitting a first signal destined for a Mobile Station (MS) to a relay node in a Multiple-Input Multiple-Output (MIMO) scheme, and upon receipt of a second signal from the relay node, detecting a third signal transmitted by the MS by exclusive OR (XOR)-operating the second signal and the first signal;
the relay node for receiving the first signal from the BS, receiving the third signal from the MS, generating the second signal by XOR-operating the first signal and the third signal, transmitting the second signal to the BS and the MS in a Spatial Division Multiple Access (SDMA) scheme; and
the MS for transmitting the third signal to the relay node and upon receipt of the second signal, detecting the first signal transmitted by the BS by XOR-operating the second signal and the third signal.

13. The signal transmitting and receiving system of claim 12, wherein the BS detects the second signal by Minimum Mean Squared Error (MMSE).
